(19) United States
(12) Patent Application Publication
(10) Pub. No.: US 2025/0192845 A1
(43) Pub. Date: Jun. 12, 2025

(54) User Equipment Configuration for Channel State Information Reporting

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Wei ZENG, Saratoga, CA (US); Weidong YANG, San Diego, CA (US); Yushu ZHANG, Beijing (CN)

(21) Appl. No.: 18/847,443

(22) PCT Filed: Mar. 18, 2022
(86) PCT No.: PCT/CN2022/081732

§ 371 Date: Sep. 16, 2024

(51) Int. Cl. H04B 7/06; H04W 24/10; H04W 72/0446

(52) U.S. Cl. CPC H04B 7/0626; H04B 7/0639; H04W 24/10; H04W 72/0446

(57) ABSTRACT

A user equipment (UE) is configured to send channel state information (CSI) reporting setting information associated with a time domain configuration, receive CSI configuration information comprising CSI measurement resources, wherein the CSI configuration information is based on at least the reporting setting information, receive the CSI measurement resources, perform measurements on the CSI measurement resources and report the CSI measurements in a CSI report.

### TECHNICAL FIELD

The present disclosure generally relates to user equipment configuration for channel state information reporting.

### BACKGROUND

In a new radio (NR) network, time domain correlation for channel state information (CSI) reporting have not been adequately exploited. Instead, NR networks exploit the channel spatial and frequency correlation to support CSI reporting. However, these channel correlations do not account for wireless channels that are time varying and thus have certain channel coherence time. For example, a user equipment (UE) operating on a wireless channel may encounter an environmental change or suddenly increase in movement speed. In NR, there is no existing solution to address this type of timing issue with regards to the UE. This results in an inefficient use of network resources and may cause a user equipment (UE) to experience a power drain. Accordingly, there is a need for enhancements that adequately exploit the timing property of the channel for UE CSI reporting.

### SUMMARY

Some exemplary embodiments are related to a processor of a user equipment (UE) configured to send channel state information (CSI) reporting setting information associated with a time domain configuration, receive CSI configuration information comprising CSI measurement resources, wherein the CSI configuration information is based on at least the reporting setting information, receive the CSI measurement resources, perform measurements on the CSI measurement resources and report the CSI measurements in a CSI report.

Other exemplary embodiments are related to a processor of a user equipment (UE) configured to receive CSI configuration information comprising CSI measurement resources from a network, receive the CSI measurement resources, perform measurements on the CSI measurement resources, determine whether a channel state of a channel associated with the CSI measurement resources has changed by a predetermined value since measurement of previous CSI measurement resources and skip reporting the CSI measurements to the network when the channel state has not changed by the predetermined value.

Further exemplary embodiments are related to a processor of a user equipment (UE) configured to receive CSI configuration information comprising CSI measurement resources from a network, receive the CSI measurement resources, perform measurements on the CSI measurement resources, indicate a duration for which the CSI measurements are valid in a CSI report and transmit the CSI report to the network.

Additional exemplary embodiments are related to a processor of a user equipment (UE) configured to receive CSI configuration information comprising CSI measurement resources from a network, receive the CSI measurement resources, perform measurements on the CSI measurement resources and report the CSI measurements in a partial CSI report to the network, wherein the partial CSI report comprises differential CSI measurements.

Still further exemplary embodiments are related to a processor of a user equipment (UE) configured to receive CSI configuration information comprising CSI measurement resources from a network, receive the CSI measurement resources, perform measurements on the CSI measurement resources, compress a time domain component of the CSI measurements in a CSI report and transmit the CSI report to the network.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram of channel state information (CSI) reporting enhancements according to various exemplary embodiments.

FIG. 5 shows an example CSI reporting where the UE reports preferred CSI reporting settings to the base station according to various exemplary embodiments.

FIG. 6 shows an example CSI reporting where the UE triggers an aperiodic CSI report according to various exemplary embodiments.

FIG. 7 shows an example CSI reporting where the UE only reports CSI when the channel changes significantly according to various exemplary embodiments.

FIG. 8 shows an example CSI reporting where the UE reports a time for which the CSI report is valid according to various exemplary embodiments.

FIG. 9 shows an example CSI reporting 900 where the UE reports differential CSI measurements according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for a user equipment (UE) to report information to a base station to enhance the Channel State Information (CSI) reporting configured by the base station. As will be described in more detail below, some of the exemplary techniques described herein may enable a UE to implement time efficient feedback that may be used to configure the CSI reporting by the base station.

The exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc. Therefore, the UE as described herein is used to represent any electronic component that directly communicates with the network and presents content to the user. In other configurations, the UE may be a wearable device that communicates directly with the network and presents content to the user. Therefore, the UE as described herein is used to represent any electronic component that directly communicates with the network.

CSI reporting is based on CSI reference signals (CSI-RS or SSB) that are transmitted by a base station in the downlink (DL). A UE measures the CSI-RS or SSB and reports the measurements back to the base station in a CSI feedback report. The measurements of the CSI-RS or SSB and subsequent feedback may be used by the base station to understand the characteristics of a radio channel. This information may be used by the base station to select modulation and coding schemes (MCS), beam forming, etc. The network may also use this information for the purposes of mobility. Examples of the CSI feedback (e.g., measurements) include reference signal received power (CSI-RSRP), reference signal received quality (CSI-RSRQ), signal to interference noise ratio (CSI-SINR), etc.

The configuration of the CSI reporting (e.g., CSI-RS configuration, CSI feedback configuration, etc.) is determined by the network (e.g., the base station). However, the UE may have information that is useful for this configuration. This information may, for example, be related to time domain parameters. To provide a specific example, it may be considered that the UE understands the current measurements of the CSI-RS and the mobility state of the UE (e.g., the UE is currently stationary). This may lead to the UE understanding that the channel(s) currently being measured with respect to the CSI-RS will remain relatively stable (e.g., coherent) for a period of time. This coherence time information may be useful for the configuration of the CSI reporting. However, the information is known to the UE which is not involved in the CSI reporting configuration.

The exemplary embodiments introduce CSI reporting enhancements based on information that is known to the UE in the time domain, e.g., how long the channel will remain coherent. As will be described in more detail below, CSI feedback and/or reporting enhancements are introduced to adequately exploit the time domain correlation in CSI reporting with regards to the UE to improve the UE and network performance and reduce the network resource allocation. In addition, the enhancements reduce the CSI overhead and provide a more accurate adaptation to varying channel conditions.

In one aspect, the exemplary embodiments introduce a technique for the UE to report preferred CSI reporting setting(s) that may be used by the network when configuring the CSI reporting. In another aspect, the exemplary embodiments introduce a technique for the UE triggering aperiodic CSI (AP-CSI) reporting. In a further aspect, the exemplary embodiments introduce a technique for the UE to skip certain CSI reports when the channel remains relatively constant. In another aspect, the exemplary embodiments introduce a technique for enhancing the CSI report with an indication of the duration of the validity of the CSI report. In another aspect, the exemplary embodiments introduce a mechanism for reporting the CSI measurements as differential measurements. In yet another aspect, the exemplary embodiments introduce a technique for CSI time domain compression configured by the UE.

As will be described in more detail below, the above techniques are introduced to enhance the CSI feedback and/or reporting to improve UE power saving and performance and network performance in the time domain. The exemplary CSI feedback enhancements described herein may be used in conjunction with currently implemented CSI feedback and/or reporting techniques, future implementations of CSI feedback and/or reporting techniques or independently from other CSI feedback and/or reporting techniques.

Throughout this description, the information that is provided from the UE to the network (e.g., gNB) may be reported in various manners. In some exemplary embodiments, the information is reported reporting via the CSI feedback reporting that is configured by the network. In other exemplary embodiments, the UE may report the information via other reporting mechanisms, e.g., Radio Resource Control (RRC) signaling, Medium Access Control (MAC) signaling, etc. Thus, when a specific example of a reporting mechanism is provided in the following example, it should be understood that the example is merely for illustrative purposes and other reporting mechanisms may be used.

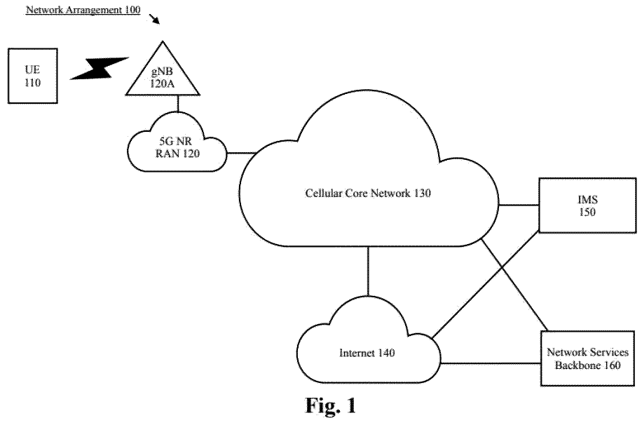

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

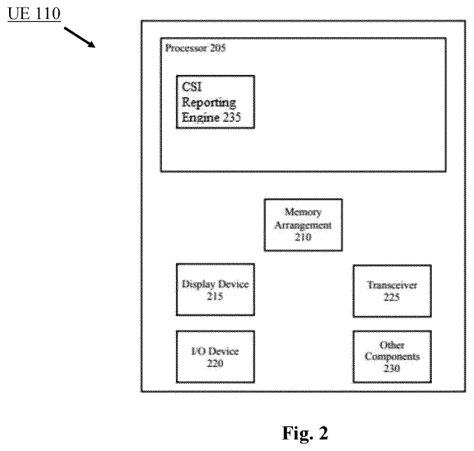

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a CSI reporting engine 235. The CSI reporting engine 235 may perform various operations related to the exemplary CSI reporting enhancements described herein. These operations may include, but are not limited to, indicating a preferred CSI setting, triggering an AP-CSI reporting, generating AP-CSI reporting based on a P/SP CSI-report configurations, enhancing the AP-CSI reporting, generating CSI time domain differential reporting and generating CSI time domain compression. Each of these various operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

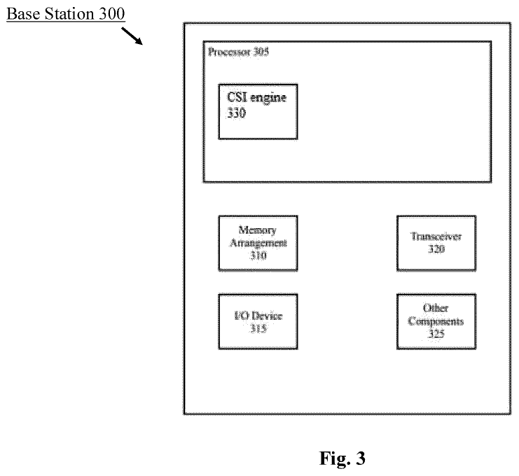

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a CSI engine 330. The CSI engine 330 may perform various operations related to the exemplary CSI reporting enhancements in the time domain described herein. The operations may include but are not limited to, transmitting CSI reporting configuration information, transmitting CSI resources configuring CSI reporting setting and receiving CSI reporting setting as CSI feedback. Each of these various operations will be described in greater detail below.

The above noted engine 330 being an application (e.g., a program) executed by the processor 305 is only exemplary. The functionality associated with the engines 330, 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

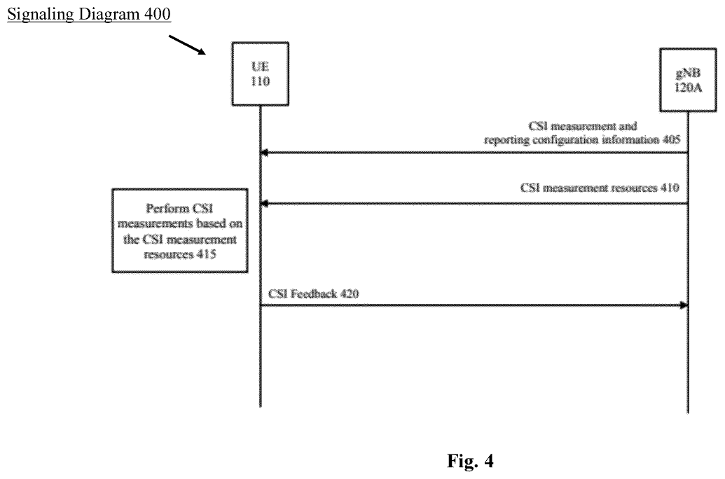

As described above, the exemplary embodiments are related to various CSI reporting enhancements related to information that may be provided by the UE to the network. The following will provide examples of different types of information the UE 110 may provide the network to enhance the CSI reporting configuration. Prior to providing the examples, a general overview of the CSI configuration and reporting will be provided in FIG. 4.

FIG. 4 shows a signaling diagram 400 of CSI reporting according to various exemplary embodiments. The signaling diagram 400 provides an overview of CSI reporting process. The signaling diagram 400 is described with regard to the network arrangement 100 of FIG. 1, the UE 110 of FIG. 2 and the base station 300 (e.g., gNB 120A) of FIG. 3.

In 405, the UE 110 receives CSI measurement and/or reporting configuration information, referred to herein as CSI configuration information. In some embodiments, the CSI configuration information may be provided to the UE 110 in one or more radio resource control (RRC) messages. In other embodiments, the CSI configuration information may be provided to the UE 110 in one or more access control (MAC) control elements (CEs). However, the exemplary embodiments are not limited to RRC messages or MAC CEs, the CSI configuration information may be provided to the UE 110 in any appropriate manner.

In 410, the gNB 120A configures CSI measurement resources to the UE 110 (e.g., CSI-RS). The CSI resources may include channel measurement resources (CMR). The CMRs may include one or more CSI-reference signals (RS). In NR, periodic and semi-persistent CMRs are supported. The periodicity and offset of these CMRs resources may be characterized in slots or in any other appropriate manner. Throughout this description, any reference to a particular type of CMR is merely provided for illustrative purposes, the exemplary embodiments may apply to any appropriate type of CMR.

In 415, the UE 110 performs CSI measurements based on the CSI measurement resources. In 420, the UE 110 reports CSI feedback to the gNB 120A via a CSI report. Examples of the CSI feedback were provided above.

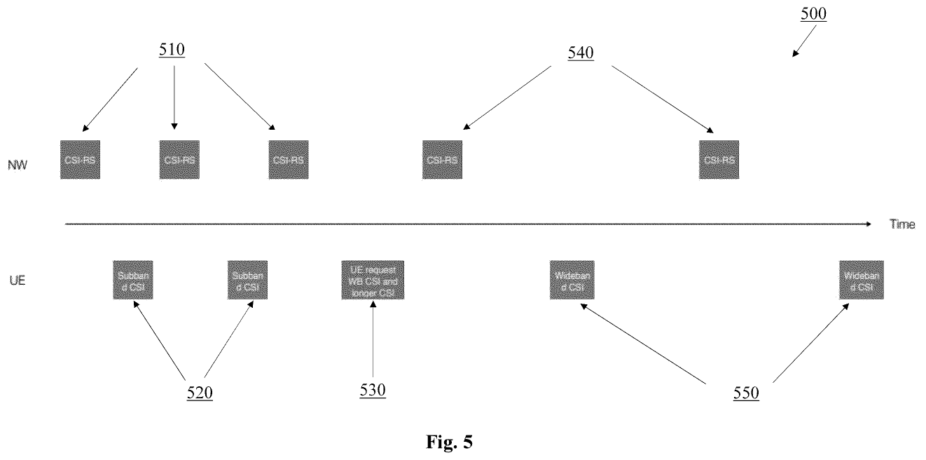

FIG. 5 shows an example CSI reporting 500 where the UE 110 reports preferred CSI reporting settings to the base station 300 according to various exemplary embodiments. The CSI reporting 500 will be described with regard to the base station 300 (e.g., gNB 120A) and the UE 110. The CSI reporting 500 provides an example of a preferred CSI reporting setting information sent to gNB 120A by the UE 110. In some embodiments, the UE 110 may present the preferred CSI reporting setting as CSI feedback to the gNB 120A. In other exemplary embodiments, the UE 110 may present the preferred CSI reporting setting as an independent CSI reporting signal to the gNB 120A.

In the CSI reporting 500, the gNB 120A configures CSI measurement resources 510 such as CSI-RS for the UE 110. The gNB 120A may configure the CSI measurement resources 510 periodically to the UE 110. For instance, the gNB 120A may configure the UE 110 to receive the CSI measurement resources 510 at specific time intervals within a defined time. The UE 110 performs CSI measurements based on the CSI measurement resources 510 and reports CSI feedback to the gNB 120A via a CSI report. In 520, the UE 110 reports the CSI feedback as a CSI subband to the gNB 120A. Those skilled in the art will understand that the CSI subband is only exemplary, and the CSI feedback may be reported in any appropriate manner.

In an exemplary embodiment, the UE 110 may suggest a preferred CSI reporting setting to the gNB 120A based on the performed CSI measurements and any other information available to the UE 110. The gNB 120A may configure the CSI measurement resources 510 to reflect the preferred CSI reporting setting, taking into consideration the preferred CSI reporting setting suggested by the UE 110. In an exemplary embodiment, the UE 110 may generate a CSI reporting suggestion as a CSI feedback based on the CSI measurements of the periodic CSI-RS 500 reported to the UE 110. Some examples of the preferred CSI settings will be provided below.

In one example, the UE 110 may generate feedback based on the channel coherence time while performing CSI measurements. The UE 110 may identify a time duration over which the channel is likely to remain relatively constant without significant changes when CSI measurements are performed. The UE 110 may explicitly report this coherence time to the gNB 120A. Based on the coherence time reported by the UE 110, the gNB 120A may configure a delay or periodicity in CSI reporting for the UE 110.

In another example, the UE 110 may determine based on the CSI measurements performed and the current channel state that a periodic CSI-RS or a semi-persistent CSI may be the preferred CSI reporting setting. In this example, the preferred CSI reporting setting reported by the UE 110 may include the preferred periodicity and offset of the CSI-RS (e.g., CSI-ResourcePeriodicityAndOffset). The UE 110 may suggest to the gNB 120A, a CSI reporting schedule of periodic or semi-persistent CSI-RS at a periodicity of X millisecond (ms) within a Y time period where X represents a time interval within Y to enhance the efficiency of the CSI reporting. Based on the UE 110 suggestion, the gNB 120A may configure periodic CSI reporting periodicity (e.g., CSI-ReportPeriodicAndOffset) or semi-persistent CSI reporting periodicity (reportSlotConfig and reportSlotOffsetList).

Referring back to FIG. 5, after the transmission of the CSI measurement resources 510 and the CSI report 520, the UE 110 may report the preferred CSI reporting setting within the CSI report 530. In CSI report 530, the UE 110 may request a wideband CSI and longer CSI reporting taking into consideration the current channel state. The gNB 120A may consider the CSI report 530 and configure CSI measurement resources 540. In this example, it can be seen that the CSI measurement resources 540 are configured to have a longer periodicity than the CSI measurement resources 510. In addition, the UE 110 is configured to report the CSI feedback via a CSI report 550 in the wideband as opposed to the CSI subband of the CSI report 520. It should be understood that the example of FIG. 5 is only for illustrative purposes and the gNB 120A may configure the CSI measurement resources 540 in any appropriate manner considering the preferred CSI reporting setting included in the CSI report 530. In addition, as stated above, the preferred CSI reporting setting may be reported in a separate signaling between the UE 110 and the gNB 120A, e.g., the preferred CSI reporting setting is not required to be sent in the CSI feedback.

In further exemplary embodiments, the UE 110 may generate CSI reporting setting information prior to receiving the CSI configuration information and related CSI measurement resources 510 from the gNB 120A. Accordingly, the UE 110 may generate a preconfigured CSI reporting setting for UE 110 at different times within a defined time period. The preconfigured settings may be suggested to the gNB 120A through a separate feedback signal. The gNB 120A may consider the preconfigured settings received from the UE 110 and configure the UE 110 to report CSI measurement resources at time intervals proposed by the UE 110.

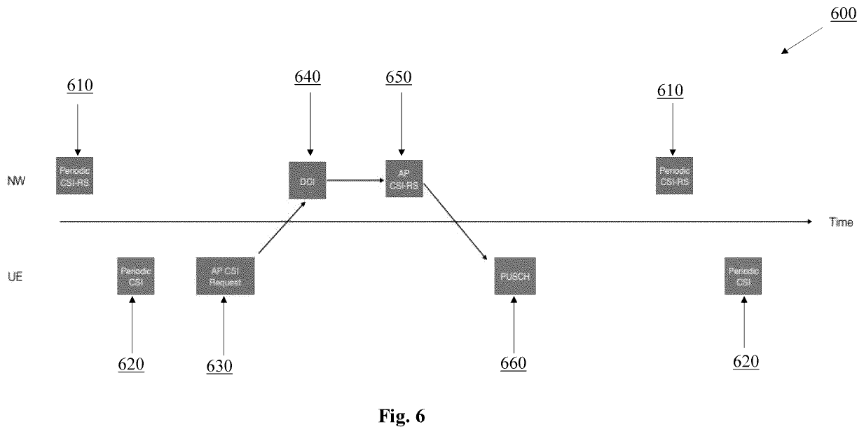

FIG. 6 shows an example CSI reporting 600 where the UE 110 triggers an aperiodic CSI report according to various exemplary embodiments. The CSI reporting 600 provides an example of the UE 110 triggering an aperiodic CSI (AP-CSI) report. In some embodiments, the UE 110 may trigger the AP-CSI reporting within the CSI feedback reported to the gNB 120A. In other embodiments, the UE 110 may trigger the AP-CSI reporting as an independent CSI reporting signal to the gNB 120A. This trigger that is sent by the UE 110 may be considered another type of CSI reporting setting information.

Initially, the gNB 120A configures periodic CSI measurement resources 610 such as periodic CSI-RS for the UE 110. The UE 110 performs CSI measurements based on the CSI measurement resources 610 and reports the periodic CSI report 620 to the gNB 120A. In an exemplary embodiment, while performing the CSI measurements or based on other factors (e.g., movement of the UE 110, detection of an obstruction, etc.), the UE 110 may detect a significant change in the channel state. As a result, the UE 110 may generate a request to the gNB 120A in the form of a CSI reporting signal 630. The CSI reporting signal 630 may include an AP-CSI request to the gNB 120A.

The CSI reporting signal 630 may also include additional information that the gNB 120A may use to configure the AP-CSI. The following will provide several examples of additional information that may be included in the CSI reporting signal 630 but it should be understood that these are only examples and the exemplary information is not required to be included in the CSI reporting signal 630 and that the additional information is not limited to the following examples, and other examples of additional CSI configuration information may be included in the CSI reporting signal 630.

For example, the UE 110 may indicate to the gNB 120A whether a wideband CSI or subband CSI feedback may be preferred. In another example, the UE 110 may indicate a preferred codebook reporting Type (e.g., Rel-15 Type I, Rel-15 Type II, Rel-16 Type II, or Rel-17 Type II). In a further example, the UE 110 may indicate a preferred CSI-RS resource configuration with regards to the number of number of ports, number of CSI-RS resources, etc.

In a still further example, the UE 110 may indicate the preferred timing to initiate the AP CSI request to the gNB 120A within a given time period. For example, the CSI reporting signal 630 may include a preferred timing for Downlink Control Information (DCI) to AP-CSI-RS and a preferred time from AP-CSI-RS to Physical Uplink Shared Channel (PUSCH) transmission based on the performed CSI measurements and the significant change in channel state. To provide an example, the UE 110 may detect a significant state change at time X. Based on the state change at time X, the UE 110 may indicate an AP CSI request at 630 suggesting to the gNB 120A the time from transmission of to the transmission of the AP-CSI-RS 650.

The gNB 120A may consider the AP-CSI request 630 and generate the DCI 640 including the AP-CSI configuration information that includes the CSI measurement resources 650 at the suggested time. The UE 110 may perform the AP-CSI measurements and report the CSI report 660 on the PUSCH. The gNB 120A may then transmit the periodic CSI-RS 610 on the normal schedule and receive the CSI report 620 for this periodic CSI transmission. Thus, in this example, the UE 110 triggered an AP-CSI report between periodic CSI reporting. However, it is not required that the UE 110 triggers the AP-CSI between periodic CSI reports, e.g., the UE 110 may trigger AP-CSI reports regardless of whether the periodic CSI is configured.

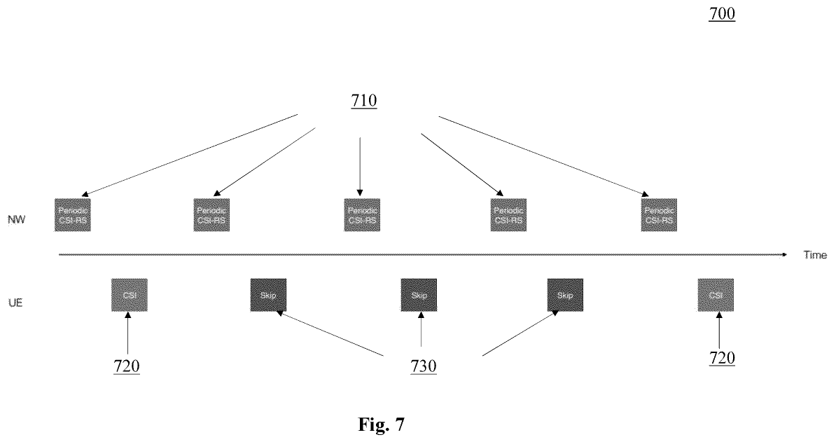

FIG. 7 shows an example CSI reporting 700 where the UE 110 only reports CSI when the channel changes significantly according to various exemplary embodiments. The example of FIG. 7 describes the skipping of CSI reports with respect to a configured periodic CSI report. However, it should be understood that the exemplary embodiments may also apply to semi-persistent CSI reporting to the gNB 120A.

Initially, the gNB 120A configures periodic CSI measurement resources 710 and reporting of the CSI feedback on the Physical Uplink Control Channel (PUCCH) or the PUSCH. The gNB 120A transmits the first CSI-RS 710. The UE 110 performs the CSI measurements based on CSI measurement resources 710 and reports the CSI report 720 to the gNB 120A on the PUCCH or PUSCH as configured.

The gNB 120A then transmits the second CSI-RS 710. However, the UE 110 may determine that there has been no significant change to the channel since the first CSI report 720 was reported to the gNB 120A. Thus, the UE 110 skips the CSI report 730 because there has been no significant change in the channel. The definition of a significant change may be based on any parameter measured by the UE 110 for the CSI-RS, e.g., CSI-RSRP, CSI-RSRQ, CSI-SINR, etc. In addition, the skipping of the CSI report 730 does not mean that the UE 110 does not report any information to the gNB 120A. For example, the CSI report 730 may include information describing the stable state of the channel. This information may include a special low payload or reserve content transmitted on the PUCCH or PUSCH transmission, e.g., a bit indicating no significant change to the channel, a bit indicating that the CSI report is being skipped for the current CSI measurement resources 710, etc.

In another aspect of the CSI reporting 700, the CSI report 730 that is considered to be skipped may be dropped when it is multiplexed with other UL transmissions such as PUSCH, scheduling request (SR), acknowledgement (ACK) signals or not acknowledged (NAK) signals, etc., due to the level of priority with regards to the other transmissions. Thus, the UE 110 may drop the CSI report 730 if it collides with other UL channel transmissions as a suggestion to the gNB 120A.

In the example of FIG. 7, the CSI report for the second, third and fourth instances of the CSI-RS 710 have been skipped. However, after the fifth instance of the CSI-RS 710, the UE 110 may provide a full CSI report 720 to the gNB 120A. This may be due to the channel changing significantly or the gNB 120A may configure the UE 110 to only skip a predetermined number of CSI reports or CSI reports for a predetermined period of time.

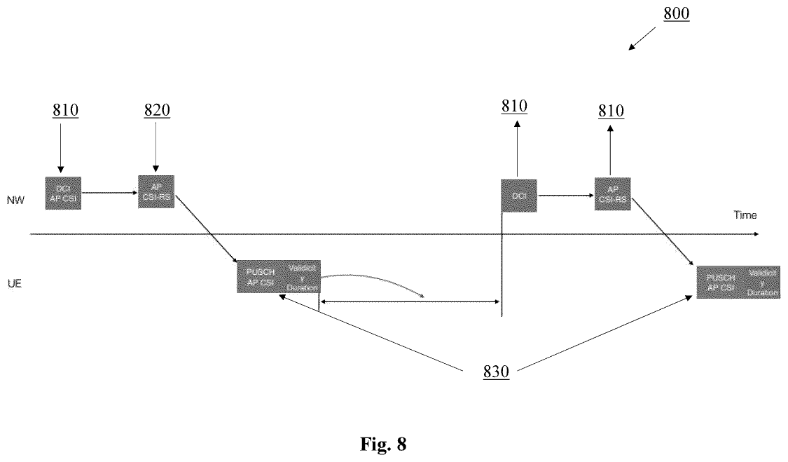

FIG. 8 shows an example CSI reporting 800 where the UE 110 reports a time for which the CSI report is valid according to various exemplary embodiments. Specifically, the UE 110 indicates to the gNB 120A the period of time for which the CSI report is valid, e.g., how long the UE 110 expects the channel conditions to remain relatively constant. This exemplary embodiment is described with respect to AP-CSI reporting. However, it should be understood that this exemplary embodiment may also be applicable to periodic or semi-persistent CSI reporting.

Initially, the gNB 120A configures an AP-CSI and transmits this configuration to the UE 110 via DCI 810. The gNB 120A may then transmit the AP CSI measurement resource 820. The UE 110 performs the CSI measurements based on the AP CSI measurement resource 820 and reports a CSI report 830 to the gNB 120A (e.g., via a PUSCH transmission). Additionally, the CSI report 830 may also include a duration for which the CSI feedback is valid.

To provide an example, based on the CSI measurements, the UE 110 may determine a duration for which the UE 110 predicts the CSI report will be valid, e.g., how long the UE 110 predicts the channel will remain stable. The UE 110 may report the duration of the validity of the CSI report 830 to the gNB 120A in various manners. For example, the duration may be reported in absolute time (e.g., ms), in slots, in symbols, etc., where the subcarrier spacing (SCS) may be either in terms of the DCI, CSI-RS OR PUSCH (e.g., minimum or maximum).

In the scenario where the CSI reports are AP-CSI reports, the expiration of the duration implies that a new CSI report should be triggered. This is illustrated in FIG. 8, where after the duration included in the CSI report 830 has expired, the gNB 120 configures a new AP-CSI and transmits this configuration to the UE 110 via the second DCI 810. The gNB 120A may then transmit the second AP CSI measurement resource 820. The UE 110 performs the CSI measurements based on the AP CSI measurement resource 820 and reports the CSI report 830 to the gNB 120A including another duration for which the CSI report 830 is valid.

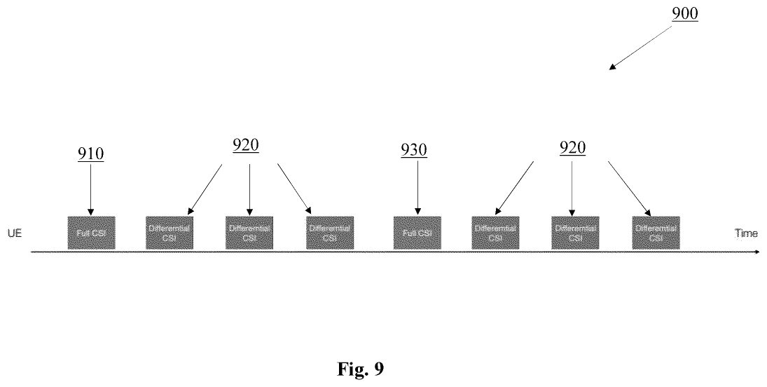

FIG. 9 shows an example CSI reporting 900 where the UE 110 reports differential CSI measurements according to various exemplary embodiments. Differential CSI measurements refer to a reporting where the change from the previous reporting is reported rather than the absolute measurement. For example, if a first CSI measurement by the UE 110 is 80 dB, this full reporting of the 80 dB measurement may be reported by the UE 110 to the gNB 120A. The second CSI measurement may be 83 dB. Instead of the UE 110 reporting the absolute measurement of 83 dB, the UE 110 may report the differential measurement of +3 dB. In some exemplary embodiments, the CSI report may include a channel quality information (CQI) measurement and the differential CSI report may include a differential CQI. However, the differential report is not limited to this type of measurement. It should be understood that this differential CSI measurement may save reporting overhead versus the full CSI reporting. The example of FIG. 9 is described with respect to periodic CSI reporting. However, the exemplary embodiments may also be applied to semi-persistent or aperiodic CSI reporting. In addition, throughout this description the differential CSI reporting may be referred to as a differential CSI report or a partial CSI report.

Initially, in the CSI reporting 900, the UE 110 performs the CSI measurements on the CSI measurement resources configured by the gNB 120A (not shown). The UE 110 sends a full CSI report 910 to the gNB 120A, e.g., the normal CSI report that includes the full reporting configured by the gNB 120A. After the next set of CSI measurements, the UE 110 may report a partial CSI report 920 as a differential CSI such as the example provided above. Similarly, the next two CSI reports 920 may also be partial differential CSI reports.

After one or more differential CSI reports 920, the UE 110 may then provide another full CSI report 930. In some exemplary embodiments, the gNB 120A may configure when the UE 110 sends the full CSI report. For example, the gNB 120A may configure a predetermined number of consecutive differential CSI reports that may be reported, a predetermined time during which differential CSI reports may be used, etc. Further examples of when a full CSI report should be sent after one or more differential CSI reports will be provided below. After the second full CSI report 930, the UE 110 may then return to sending differential CSI reports 920 to the gNB 120A.

As described above, there may be multiple manners of resetting the differential CSI reporting by reporting a full CSI report periodically. In one example, the periodicity and slot offset is configured by the network (e.g., gNB 120A). In another example, AP-CSI reporting may be a full CSI report, while periodic or semi-persistent reporting is differential, e.g., an AP-CSI is the resetting mechanism. In a further example, when the UE 110 is to report a predetermined CSI parameter such as a precoding matrix indicator (PMI), the UE 110 may provide a full CSI report, e.g., the resetting mechanism is the type of parameter that is to be reported in the CSI report.

In another example, the UE 110 may report the different types of CSI reports (full or differential) on different UL PHY channels. For example, the UE 110 may report the full CSI report over the PUSCH and the differential CSI reporting over the PUCCH. Those skilled in the art will understand that these channels are only exemplary and other appropriate channels or channel combinations may be utilized.

In another example, the different types of CSI reports (full or differential) may have different UL priorities when being multiplexed with other UL payload. For example, a listing of UL payload priorities may be HARQ-ACK/NAK>UL SR>UL full CSI report>UL data>UL partial CSI report. Thus, when the UE 110 is multiplexing payload data in the UL, the UE 110 may prioritize the payload data in accordance with the exemplary priority. It should be understood that the above priority list is only exemplary and that a different set of priorities may be assigned to each of the different types of UL payload. The example was used to illustrate that a full CSI report may have a different priority than a partial CSI report.

In another example, the UE 110 may use differential encoding on a CQI as a mode of CSI reporting to the gNB 120A. For example, the UE 110 may report the differential CQI as a step size of the previous differential report. For example, the UE 110 may be configured by the gNB 120A to generate a step size of T where T is (e.g., 0.5 dB, 1 dB, 1.5 dB, 2 dB, etc.). Thus, instead of reporting the differential CQI in a numerical value of dB, the UE 110 may report the subsequent differential CQI in step sizes. In another aspect, the UE 110 may be configured with a range foe reporting the step size from +AdB to −BdB with a step size of T, for example [−7 Db+7 Db]. Thus, when subsequent differential CQI measurements falls within the range, the UE 110 may be configured to report the differential in a step size. However, if the differential CQI measurement falls outside the range, there may be a reservation bit used to indicate that the differential value may be larger than upper-limit or may be smaller than the lower-limit within the range.

In a further example, the UE 110 apply the differential encoding on a PMI (e.g., W1 or W2 matrix). In one example, the UE 110 may apply the differential encoding for Type I CSI PMI reporting in terms of the preferred spatial basis index offset. In another example, the UE 110 may apply differential encoding during Type II CSI PMI reporting when the CSI reporting remains unchanged with regards to the spatial basis selection. Additionally, or alternatively, the differential encoding may be applied in terms of the coefficient offset. However, the amplitude and phase coefficient may have independent differential reporting applications.

In further exemplary embodiments, the CSI reporting may provide CSI time domain compression. To provide an example, the UE 110 may use CSI time domain compression in the form of a discrete Fourier transform (DFT) sequence/waveform to the gNB 120A for CSI reporting. The DFT sequence/waveform may be presented in the equation:

$${w}_{n} ( t ) = exp ( - j \frac{2 π}{T} * \frac{n * {O}_{4} + k}{{O}_{4}} * t ) \qquad k = 0 , 1 , 2 , {O}_{4} - 1$$

where T is the duration of the prediction, O₄ is the oversampling ratio and k is the picked over sampling offset.

In another example, the UE 110 may discretize the DFT waveform if the duration T is divided into integer subsets. That is, the UE 110 may be configured by the gNB 120A compress the CSI report with a higher resolution.

In another example, the UE 110 may be configured to report the actual CSI. However, after reporting the actual CSI, the UE 110 may report the CSI as a summation. In one aspect, the UE 110 may indicate a preference for the oversampling offset k for reporting the CSI. In another aspect, the UE 110 may report the preferred list of n for the DFT basis index. The summation may be determined with the following equation:

$$CSI ( t ) = CSI * {\sum }_{i} {w}_{i} * {w}_{{n}_{i}} ( t ) = CSI * {\sum }_{i} {w}_{i} * exp ( - j \frac{2 π}{T} * \frac{{n}_{i} * {O}_{4} + k}{{O}_{4}} * t ) .$$

In another example, the UE 110 may report the CSI as a CSI content. For example, the CSI content may be in the form of a CQI, or for Type I or Type II CSI reporting, the CSI content may be a linear combination coefficient.

In another example, a weighting coefficient (wᵢ) may be defined for each selected time domain DFT basis. In one aspect, the gNB 120A may configure the UE 110 to quantize the amplitude for the weighting coefficient. For example, to determine the strongest time domain DFT basis, the first weighting coefficient may be used as the reference whose amplitude does not need to be reported. Thus, the first weighting coefficient may be assumed to be 1. In another example, the amplitude of wᵢ for the rest of time domain DFT basis can be quantized based on differential encoding using the strongest basis as reference.

In another aspect, the gNB 120A may configure the UE 110 to quantize the phase of wᵢ. For example, the strongest time domain DFT basis can be the reference whose phase does not need to be reported. Thus, the first phase may be assumed to be 0. In another example, the phase of wᵢ for the rest of time domain DFT basis may be quantized based on differential encoding using the strongest basis as reference.

### Examples

In a first example, a user equipment comprises a transceiver configured to communicate with a network and a processor communicatively coupled to the transceiver and configured to send channel state information (CSI) reporting setting information associated with a time domain configuration, receive CSI configuration information comprising CSI measurement resources, wherein the CSI configuration information is based on at least the reporting setting information, receive the CSI measurement resources, perform measurements on the CSI measurement resources and report the CSI measurements in a CSI report.

In a second example, the UE of the first example, wherein the time domain configuration comprises a coherence time for the channel associated with the CSI configuration information.

In a third example, the UE of the first example, wherein the time domain configuration information comprises a periodicity and offset for periodic CSI reporting.

In a fourth example, the UE of the first example, wherein the time domain configuration information comprises a slot configuration and a slot offset for semi-persistent CSI reporting.

In a fifth example, the UE of the first example, wherein the processor of the UE is further configured to detect a change in a channel state that exceeds a predetermined value, wherein the CSI reporting setting information comprises a request that an aperiodic CSI (AP-CSI) be triggered.

In a sixth example, the UE of the fifth example, wherein the CSI reporting setting information further comprises a wideband CSI feedback or a subband CSI feedback as a preferred CSI setting.

In a seventh example, the UE of the fifth example, wherein the CSI reporting setting information further comprises a preferred codebook reporting type.

In an eighth example, the UE of the fifth example, wherein the CSI reporting setting information further comprises a preferred CSI-reference signal (CSI-RS) resource configuration.

In a ninth example, the UE of the fifth example, wherein the CSI reporting setting information further comprises a preferred timing for the AP-CSI.

In a tenth example, the UE of the ninth example, wherein the preferred timing comprises a timing from (i) a Downlink Control Information (DCI) configuring the AP-CSI to AP-CSI reference signals (AP-CSI-RS) or (ii) a timing from the AP-CSI-RS to a Physical Uplink Shared Channel (PUSCH) transmission by the UE for the CSI reporting.

In an eleventh example, a user equipment comprises a transceiver configured to communicate with a network and a processor communicatively coupled to the transceiver and configured to receive CSI configuration information comprising CSI measurement resources from a network, receive the CSI measurement resources, perform measurements on the CSI measurement resources, determine whether a channel state of a channel associated with the CSI measurement resources has changed by a predetermined value since measurement of previous CSI measurement resources and skip reporting the CSI measurements to the network when the channel state has not changed by the predetermined value.

In a twelfth example, the UE of the eleventh example, wherein, when the UE skips the reporting of the CSI measurements, the processor of the UE is further configured to send an indication to the network that the channel state has not changed by the predetermined value since the measurement of the previous CSI measurement resources.

In a thirteenth example, the UE of the twelfth example, wherein the indication has a lowest priority when multiplexed with other uplink (UL) control or data payload.

In a fourteenth example, a user equipment comprises a transceiver configured to communicate with a network and a processor communicatively coupled to the transceiver and configured to receive CSI configuration information comprising CSI measurement resources from a network, receive the CSI measurement resources, perform measurements on the CSI measurement resources, indicate a duration for which the CSI measurements are valid in a CSI report and transmit the CSI report to the network.

In a fifteenth example, the UE of the fourteenth example, wherein the CSI configuration information is for one of an aperiodic CSI, a periodic CSI or a semi-persistent CSI.

In a sixteenth example, the UE of the fourteenth example, wherein the indication of the duration is reported in absolute time.

In a seventeenth example, the UE of the fourteenth example, wherein the indication of the duration is reported in a number of slots or a number of symbols.

In an eighteenth example, the UE of the seventeenth example, wherein a reference subcarrier spacing (SCS) for the number of slots or symbols is based on one of a minimum or maximum of the SCS used for Downlink Control Information (DCI), Channel State Indication Reference Signals (CSI-RS) and Physical Uplink Shared Channel (PUSCH).

In a nineteenth example, a user equipment comprises a transceiver configured to communicate with a network and a processor communicatively coupled to the transceiver and configured to receive CSI configuration information comprising CSI measurement resources from a network, receive the CSI measurement resources, perform measurements on the CSI measurement resources, and report the CSI measurements in a partial CSI report to the network, wherein the partial CSI report comprises differential CSI measurements.

In a twentieth example, the UE of the nineteenth example, wherein the differential CSI measurements comprise a Channel Quality Index (CQI).

In a twenty first example, the UE of the nineteenth example, wherein the processor is further configured to receive subsequent CSI measurement resources, perform measurements on the subsequent CSI measurement resources and report the CSI measurements in a full CSI report to the network, wherein the full CSI report resets the differential CSI measurements.

In a twenty second example, the UE of the twenty first example, wherein the full CSI report is triggered by the UE receiving CSI configuration information comprising an aperiodic CSI.

In a twenty third example, the UE of the twenty first example, wherein the full CSI report is triggered by the UE receiving CSI configuration information comprising a predetermined parameter measurement.

In a twenty fourth example, the UE of the twenty first example, wherein the partial CSI report is reported via a first uplink (UL) channel and the full CSI report is reported via a different second UL channel.

In a twenty fifth example, the UE of the twenty first example, wherein the partial CSI report has a first priority when multiplexed with other uplink (UL) control payload and the full CSI report has a different second priority when multiplexed with other UL control payload.

In a twenty sixth example, the UE of the nineteenth example, wherein the differential CSI measurements comprise a step size.

In a twenty seventh example, the UE of the twenty sixth example, wherein the step size is reported within a predefined range.

In a twenty eighth example, the UE of the twenty seventh example, wherein the processor of the UE is further configured to report an indication to the network that the step size differential CSI measurement is outside the predefined range.

In a twenty ninth example, the UE of the nineteenth example, wherein the partial CSI report comprises a Type I CSI precoding matrix indicator (PMI) and the differential CSI measurements comprise a spatial basis index offset.

In a thirtieth example, the UE of the nineteenth example, wherein the partial CSI report comprises a Type II CSI precoding matrix indicator (PMI) and the differential CSI measurements comprise a coefficient offset for amplitude or phase.

In a thirty first example, a user equipment comprises a transceiver configured to communicate with a network and a processor communicatively coupled to the transceiver and configured to receive CSI configuration information comprising CSI measurement resources from a network, receive the CSI measurement resources, perform measurements on the CSI measurement resources, compress a time domain component of the CSI measurements in a CSI report and transmit the CSI report to the network.

In a thirty second example, the UE of the thirty first example, wherein the time domain compression is based on a discrete Fourier transform (DFT) waveform comprising a duration of a prediction of the CSI measurements, an oversampling ratio and an oversampling offset.

In a thirty third example, the UE of the thirty second example, wherein the DFT waveform is discretized by dividing the duration of the prediction of the CSI measurements into integer subsets.

In a thirty fourth example, the UE of the thirty first example, wherein the time domain compression is based on a summation of the CSI measurements.

In a thirty fifth example, the UE of the thirty second example, wherein the DFT comprises a weighting coefficient for each selected time domain DFT basis.

In a thirty sixth example, the UE of the thirty first example, wherein the time domain compression is applied to channel quality information (CQI) content of the CSI report.

In a thirty seventh example, the UE of the thirty first example, wherein the time domain compression is applied to linear combination coefficients of a W2 component of a precoding matrix indicator (PMI) reporting of a corresponding Type I or Type II CSI report.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor configured to:
generate channel state information (CSI) reporting setting information associated with a time domain configuration;
receive CSI configuration information comprising CSI measurement resources, wherein the CSI configuration information is based on at least the reporting setting information;
receive the CSI measurement resources;
perform measurements on the CSI measurement resources; and
generate a CSI report to report the CSI measurements.

2. The processor of claim 1, wherein the time domain configuration comprises a coherence time for the channel associated with the CSI configuration information.

3. The processor of claim 1, wherein the time domain configuration information comprises a periodicity and offset for periodic CSI reporting.

4. The processor of claim 1, wherein the time domain configuration information comprises a slot configuration and a slot offset for semi-persistent CSI reporting.

5. The processor of claim 1, further configured to:
detect a change in a channel state that exceeds a predetermined value,
wherein the CSI reporting setting information comprises a request that an aperiodic CSI (AP-CSI) be triggered.

6. The processor of claim 5, wherein the CSI reporting setting information further comprises a wideband CSI feedback or a subband CSI feedback as a preferred CSI setting.

7. The processor of claim 5, wherein the CSI reporting setting information further comprises a preferred codebook reporting type.

8. The processor of claim 5, wherein the CSI reporting setting information further comprises a preferred CSI-reference signal (CSI-RS) resource configuration.

9. The processor of claim 5, wherein the CSI reporting setting information further comprises a preferred timing for the AP-CSI.

10. The processor of claim 9, wherein the preferred timing comprises a timing from (i) a Downlink Control Information (DCI) configuring the AP-CSI to AP-CSI reference signals (AP-CSI-RS) or (ii) a timing from the AP-CSI-RS to a Physical Uplink Shared Channel (PUSCH) transmission for the CSI reporting.

11. A processor configured to:
receive CSI configuration information comprising CSI measurement resources from a network;
receive the CSI measurement resources;
perform measurements on the CSI measurement resources;
determine whether a channel state of a channel associated with the CSI measurement resources has changed by a predetermined value since measurement of previous CSI measurement resources; and
skip reporting the CSI measurements to the network when the channel state has not changed by the predetermined value.

12. The processor of claim 11, wherein, when reporting of the CSI measurements is skipped, the processor is further configured to:
generate, for transmission to the network, an indication that the channel state has not changed by the predetermined value since the measurement of the previous CSI measurement resources.

13. The processor of claim 12, wherein the indication has a lowest priority when multiplexed with other uplink (UL) control or data payload.

14. A processor configured to:
receive CSI configuration information comprising CSI measurement resources from a network;
receive the CSI measurement resources;
perform measurements on the CSI measurement resources;
indicate a duration for which the CSI measurements are valid in a CSI report; and
generate, for transmission to the network, the CSI report.

15. The processor of claim 14, wherein the CSI configuration information is for one of an aperiodic CSI, a periodic CSI or a semi-persistent CSI.

16. The processor of claim 14, wherein the indication of the duration is reported in absolute time.

17. The processor of claim 14, wherein the indication of the duration is reported in a number of slots or a number of symbols.

18. The processor of claim 17, wherein a reference subcarrier spacing (SCS) for the number of slots or symbols is based on one of a minimum or maximum of the SCS used for Downlink Control Information (DCI), Channel State Indication Reference Signals (CSI-RS) and Physical Uplink Shared Channel (PUSCH).

19-37. (canceled)
